(19) United States
(12) Patent Application Publication
(10) Pub. No.: US 2015/0233735 A1
(43) Pub. Date: Aug. 20, 2015

(54) SENSOR DEVICE FOR ACQUIRING AT LEAST ONE ROTATIONAL PROPERTY OF A ROTATING ELEMENT

(71) Applicants: Robert Bosch GmbH, Stuttgart, DE (DE); MAHLE TURBO SYSTEMS GMBH & CO., KG,,, Stuttgart (DE)

(72) Inventors: Klaus Lerchenmueller, Rettenberg (DE); Andre Yashan, Stuttgart (DE); Hartmut Weiss, Stuttgart (DE)

(21) Appl. No.: 14/426,050

(22) PCT Filed: Sep. 24, 2013
(86) PCT No.: PCT/EP2013/069870

§ 371 Date: Mar. 4, 2015

(30) Foreign Application Priority Data
Dec. 18, 2012 (DE) 10 2012 223 593.0

(51) Int. Cl. G01D 5/20; G01M 15/04

(52) U.S. Cl. CPC G01D 5/20; G01M 15/042

(57) ABSTRACT

A sensor device for acquiring at least one rotational property of a rotating element, particularly a rotational speed of a compressor wheel of an exhaust-gas turbocharger, includes at least one magnetic field generator for generating a magnetic field at the location of the rotating element, at least one magnetic sensor, e.g., a coil, for acquiring a magnetic field generated by eddy currents of the rotating element, and at least one pole pin. The pole pin is elongated at its end facing the rotating element and includes a section that is not enclosed by the magnetic sensor. The sensor can be installed as a plug sensor in a blind-end bore in the housing of the exhaust-gas turbocharger.

### BACKGROUND

Numerous sensors that acquire at least one rotational property of a rotating element, i.e., that at least partially describes the rotation of the rotating element, are known from the related art. For instance, the rotational properties may include angular speeds, rotational speeds, angular accelerations, angles of rotation, angular positions, or other properties that could characterize a continuous or discontinuous, uniform or nonuniform rotation or turning of the rotating element. Examples of such sensors are known from Konrad Reif: Sensors in the Motor Vehicle, 1st Edition 2010, pages 120-125.

A method for measuring the motion of an object part in an interior space of a housing is known from document DE 196 23 236 A1. In this case, a permanent magnetic field is generated, which acts essentially perpendicularly to a motion direction of the object, and induction signals are generated and measured when the object is passing by. The magnetic field may be generated, for example, by a permanent magnet, and the induction signals, which may be the result of eddy currents in moved compressor blades, may be detected with the aid of a coil, which is situated outside the compressor housing.

A device for rotational speed acquisition for a charging device, especially for a rotor of an exhaust-gas turbocharger, is also known from document DE 10 2007 005 769 A1. Here, permanent magnets and a sensor circuit are separately used, which are placed spatially separated from each other. A housing made of a plastic material is used, in which the permanent magnets are embedded as insertion parts. The sensor circuit is accommodated in a recess on an outer side of the wall of the housing.

In devices known from the related art, a cylindrical sensor is thus typically used, which has the smallest possible diameter and is introduced from the outside into a bore of the housing. From a standpoint of production engineering, the design of the bore for the sensor is advantageously as a blind-end bore. Such bores, known from the related art for accommodating cylindrical sensors that are pin-shaped, for example, as a rule require small diameters of the sensor, however. In blind-end bores, in comparison to through-holes, there occurs, in addition, a signal attenuation, as a rule, because of the housing material situated between the sensor and the compressor wheel. Even if, as is known from DE 10 2007 005 769 A1, the compressor housing is made of plastic, the low cross sectional areas of the sensor in conventional sensor elements, as a rule, cause comparatively low signal amplitudes, which usually, for the purpose of an interference-proof transmission, such as to an engine control unit, require a signal amplification. Since the high temperatures in the vicinity of the compressor wheel usually exclude the application of conventional semiconductor components, in sensor devices according to the related art, devices for signal amplification are usually integrated into plug elements.

### SUMMARY

Accordingly, it would be desirable to have a sensor device which, at low excitation of the sensor device, provides a high signal-to-noise ratio, with a high signal amplitude.

Accordingly, a sensor device for acquiring at least one rotational property of a rotating element is provided. As was described before, the rotational property is a property which characterizes a turning and/or rotation of the rotating element. The rotational property can, in particular, be or include a rotational speed.

A particular point of concentration of the present invention, but to which the present invention is not restricted, is a rotational speed acquisition, especially the rotational speed acquisition of charging devices, in particular in exhaust-gas turbochargers, and this rotational speed acquisition can specifically be set up to acquire a rotational speed of a rotor of the exhaust-gas turbocharger, for example, where the rotor is equipped with a plurality of equidistant compressor blades. Thus, in an example embodiment, the sensor device can particularly be used to acquire a rotational speed of a compressor of an exhaust-gas turbocharger, but, alternatively or in addition, other fields of use are also possible.

The sensor device includes at least one magnetic-field generator for generating a magnetic field at the location of the rotating element, and at least one magnetic-field sensor for recording a magnetic field generated by eddy currents of the rotating element. Furthermore, the sensor device according to the present invention includes at least one pole pin, preferably exactly one pole pin. However, the sensor device can alternatively include a plurality of pole pins. In an example embodiment, the pole pin is made of a soft magnetic material, particularly of a ferromagnetic metal, and its shape is preferably essentially cylindrical. On the inside of the sensor device, the pole pin is preferably in connection with one of the two magnetic poles of the magnetic field generator via a common contact surface. Because of its material properties, the pole pin is used essentially as a magnetic flux-conducting element, that is, for a vectorial B field. The equipotential lines of the magnetic B field are conducted by the corresponding magnetic pole of the magnetic field generator via the contact surface to the pole pin, all the way through the pole pin to an end of the pole pin facing away from the magnetic field generator, and at this end, exits from the pole pin for the further course in the direction of the corresponding magnetic antipole.

The sensor device according to the present invention is designed in such a way that the pole pin is elongated at its end, pointing towards the rotating element, which is preferably likewise the end of the pole pin facing away from the magnetic field generator. Furthermore, it is provided according to the present invention that the pole pin includes at least one section not enclosed by the magnetic sensor. The magnetic sensor can be designed as a separate component from the magnetic field generator and the pole pin, but, by the enclosing of the pole pin and/or of the magnetic field generator, it may basically also form a unit with these.

The sensor device provided especially creates the advantage that it has an increased sensitivity and particularly supplies an advantageous strong measuring signal, which is particularly obtained based on the approximately speed-proportional dependence of the signal amplitude on the compressor speed. The measuring signal can be further amplified, for example, in an electronic circuit that is preferably integrated in the speed sensor. Based on the increased signal amplitude of the measuring signal, an equally increased signal-to-noise ratio of the measuring signal sets in, which is likewise of advantage. Thereby, for instance, in comparison to sensor devices known from the related art, a measuring signal of a rotational speed of ca. 5000 revolutions per minute can be generated with a sufficient resolution, and correspondingly this low rotational speed can be acquired using the sensor device according to the present invention. In other words, the sensor devices known from the related art generate a utilizable signal amplitude only at a higher rotational speed of the rotating element and, as a result, are not able to record and resolve accurately enough rotational speeds lying below these rotational speeds.

The sensor device according to the present invention is used preferably, but not exclusively, for the rotational speed acquisition of charging devices, particularly in the field of compressor wheels of exhaust-gas turbochargers. As is well known, the compressor wheels include a plurality of approximately equidistantly situated compressor blades. The compressor blades, in this instance, are preferably made of a nonmagnetic and electrically conductive material, particularly of aluminum or a titanium alloy or another light metal alloy, and a contour of the compressor blades corresponds to the contour of the compressor housing that tapers in the region of the compressor blades. In particular, in the region of the outer section of the compressor blades that cooperates/is congruent with the contour of the compressor housing, a development by section of the compressor blades of a correspondingly electrically conductive material serves to achieve the desired eddy current effect.

In supplement, in an example embodiment, the magnetic sensor is situated, at least partially, in the housing material, particularly of aluminum, preferably in a blind-end bore in the area of the contour section of the housing. In a known manner, it can further be provided that the magnetic sensor completely fill up the blind-end bore, and in this way ensures a form-locking accommodation of the magnetic sensor.

At this point, during an increase in the sensitivity of the magnetic sensor, undertaken according to the abovementioned related art, by widening the cross section of the magnetic sensor, there likewise follows an increase in the cross sectional area of the blind-end bore. From this, there necessarily follows a greater distance, measured along a longitudinal axis of the magnetic sensor, between the magnetic sensor and the compressor blades. The blind-end bore usually has a maximum admissible depth in the housing corresponding to its width, since the wall section, which forms the blind-end bore, with its closed end facing the compressor wheel, has to have a required residual thickness of the housing in the region of the blind-end bore and the tapering contour, corresponding to the stability and stiffness of the housing. In a manner previously described, there is an interaction between the implemented diameter of the blind-end bore, or rather, the magnetic sensor and the distance of the magnetic sensor from the compressor blades. It is particularly advantageous if the magnetic sensor completely fills up the blind-end bore, and includes a pole pin, elongated according to the present invention, in this case, which is elongated beyond the plane of the maximum depth having the maximum diameter of the magnetic sensor, and in the region of the elongated pole pin has a contour preferably adapted to it, which has a lower diameter. The lower diameter permits the blind-end bore that is preferably situated in the area of the contour section of the housing, while maintaining the required residual thickness of the housing, to provide an end of the blind-end bore adapted to a contour of the magnetic sensor that is likewise adapted to the elongated pole pin.

A repeated diminution of the distance between the sensor device and the rotating element is able to be effected using a pole pin that is elongated by a section that is not enclosed by the magnetic sensor. This results in the particularly advantageous effect that the magnetic field yoke, which essentially corresponds to the distance between the end of the pole pin facing the rotating element and the rotating element, is reduced. Thereby, in a further advantageous manner, the possibility is created that, because of the elongation of the pole pin, which is used essentially as a magnetic flux-conducting element, which is able to be accommodated by the magnetic field that is to be recorded by the magnetic sensor in a region having a higher magnetic field strength, which advantageously results in a considerable increase in the signal amplitude able to be recorded by the magnetic sensor. As a function of this recorded signal amplitude, an output signal is usually generated and output.

According to one further example embodiment of the sensor device, the sensor device includes a sensor housing that preferably encloses the magnetic field generator and the pole pin circumferentially. In this connection, in an example embodiment, the sensor housing, preferably at its end pointing towards the rotating element, includes a section that tapers continuously, at least in sections. The tapered section, in this case, can advantageously approximately follow the running contour starting from the cross sectional circumference given in the area of the magnetic sensor all the way to the end of the elongated pole pin pointing to the rotating element. In an example of this embodiment of the sensor device, the recess in the sensor housing, at its end the rotating element, is contoured with a contour adapted essentially to the tapering section of the sensor device, which advantageously prevents the formation of an air gap in this region.

One further advantageous refinement of this specific embodiment is that a shape of the tapering section is conically obtuse, which corresponds in a favorable manner, with respect to production technology, essentially to a contour of a conventional twist drill preferably with a point angle of 118°. Thereby, in a particularly simple manner, the accommodation for the sensor device can be manufactured in a particularly simple manner using only one single work step while using customary twist drills.

According to a further example embodiment of the sensor device, the elongated section of the pole pin preferably extends into the tapering section of the sensor housing. In particular, the pole pin extends essentially, e.g., while leaving a thin wall thickness in the longitudinal direction of the pole pin, maximally into the tapering section.

In an example embodiment, in the case of a sensor device including a sensor housing, the sensor housing is made at least partially of a plastic material. For instance, in this connection, high temperature-resistant plastics can be used, which are known from the more recent developments for automobile high temperature applications on the internal combustion engine.

According to one further example embodiment of the sensor device, the pole pin is formed of a ferromagnetic material, such as a nickel-iron alloy, a cobalt-iron alloy or another alloy of comparable magnetic properties. In this connection, the pole pin can preferably be highly magnetically conductive, which is also designated as magnetic permeability.

According to one further example embodiment of the sensor device, the magnetic sensor includes, in particular, at least one coil, which is advantageous in that, because of the use of coils for providing a magnetic sensor working according to the eddy current principle, already at relatively low coil cross sections, an output signal can be obtained with a relatively high signal amplitude and a high signal quality as a function of the rotational motion of the rotating element. The signal quality of the output signal of a magnetic sensor that includes a coil is distinguished at high revolution numbers particularly by a comparatively high signal-to-noise ratio. At the same time, the use of coils makes it possible to avoid temperature sensitivities, which occur in semiconductor magnetic sensors or magnetoresistive sensors, for example.

In this connection, it is furthermore of particular advantage if the coil encloses the pole pin at least partially. Thereby a high magnetic flux through the pole pin, which at the same time forms a core in its region enclosed by the coil, is utilized in a particularly advantageous manner for inducing a current flow based on the eddy current effect within the coil. This current induced in the coil forms, at the same time, the basis for the output signal of the magnetic sensor. This means that optionally the induced current is able to be provided directly or as an output signal of the magnetic sensor generated as a function of the induced curent, at correspondingly provided terminal contacts of the magnetic sensor.

According to one further example embodiment of the sensor device, the pole pin is able to extend, with its end pointing towards the rotating element, preferably from the coil. In this connection, the idea, on which the present invention is based, is again taken into account, particularly in that upon insertion of the sensor device preferably in the region of a tapering contour of a compressor housing, because of the extending of the pole pin at the end of the coil pointing towards the rotating element, the magnetic field yoke located in this region is able to be reduced between the pole pin and the rotating element.

In particular, the magnetic-field generator is able to include at least one, for example, precisely one, two, three or more permanent magnets, or can be formed of these. In general, the at least one magnetic field generator, especially the at least one permanent magnet, at one of its two pole faces, can be in planar connection with the pole pin, fully or partially via an appropriate contact surface.

The magnetic field generator can in particular be at least partially enclosed by the magnetic sensor.

In addition, it is of advantage if the sensor device is designed as a plug-in sensor and thus, as a one-part module, greatly simplifies the assembly as well as the maintenance.

It is further advantageous if the plug-in sensor is able to be plugged into a bore provided to accommodate same, preferably a blind-end bore, in a housing enclosing the rotating element, preferably a compressor housing.

The specific embodiments, described above, of the sensor device as a plug-in sensor, advantageously open up the possibility that, when a cross section of the plug-in sensor is round, a rotative alignment of the plug-in sensor within the bore in the housing, relative to the rotational direction of the rotating element can be omitted. This again advantageously favors an assembly and a reduction in error susceptibility during assembly or maintenance of these specific embodiments of the sensor device.

According to a further example additional feature of an example embodiment of the sensor device as a plug sensor, an end face of the plug sensor facing the rotating element is not even, for example, it includes a convex curvature.

Furthermore, according to an example embodiment of the present invention a compressor, for example, for use in an exhaust-gas turbocharger, preferably includes a housing and a compressor wheel enclosed by the housing, the compressor wheel including a plurality of compressor blades. Furthermore, the compressor includes at least one sensor device installed in the housing, the sensor device being designed to record a rotational property of the compressor wheel.

In an example embodiment, the compressor wheel is particularly be supported rotatably about an axis. In addition, the magnetic sensor, or the sensor device includes a pole pin, as described above, with an elongated section at its end facing the compressor wheel, which is not enclosed by the magnetic sensor.

The present invention will be described below according to specific example embodiment(s), with reference to FIGS. 1-3.

### BRIEF DESCRIPTION OF THE DRAWINGS

FIG. 1 illustrates a representation of a sensor device, according to an example embodiment of the present invention.

FIG. 2 provides a detailed view of a region of a magnetic sensor of the sensor device together with an housing section in an installed state, according to an example embodiment of the present invention.

FIG. 3 shows a compressor including a sensor device mounted in the housing, according to an example embodiment of the present invention.

### DETAILED DESCRIPTION

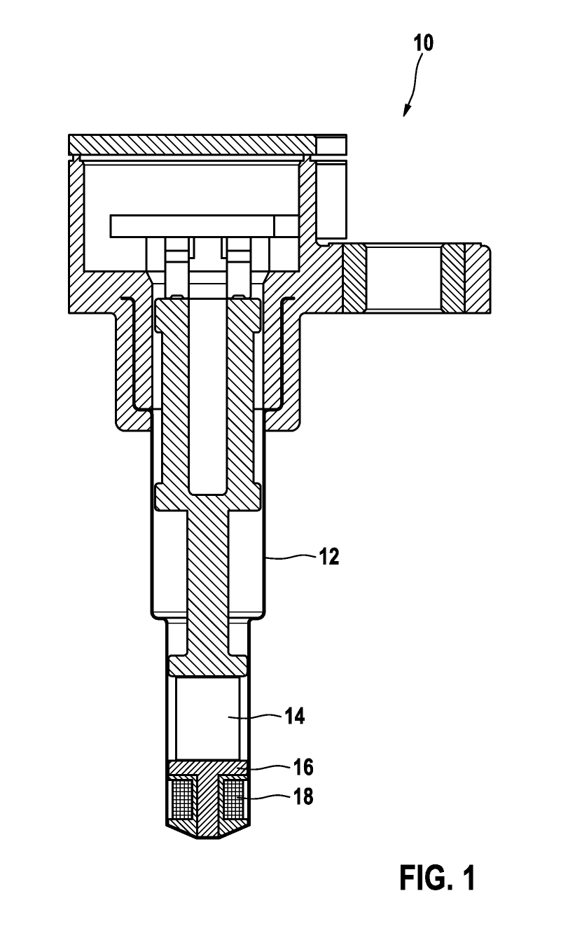

FIG. 1 shows, according to an example embodiment of the present invention, a sensor device 10 that includes a sensor housing 12 accommodating therein a magnetic field generator 14, a pole pin 16, and a magnetic sensor 18. In this case, pole pin 16, preferably as seen from magnetic field generator 14, is situated in the direction of a rotating element not shown in this illustration. In the preferred example embodiment shown, pole pin 16 is essentially T-shaped, and borders on magnetic field generator 14 with its upper surface. Furthermore, in the embodiment shown in FIG. 1, magnetic sensor 18, which may, for instance, be a coil, is situated below the horizontally running section of the essentially T-shaped pole pin 16, and furthermore encloses, preferably annularly, the section of pole pin 16 shown in a vertical form. Furthermore, in the embodiment shown in FIG. 1, pole pin 16 of sensor device 10 includes an elongated section with a length ‘a’.

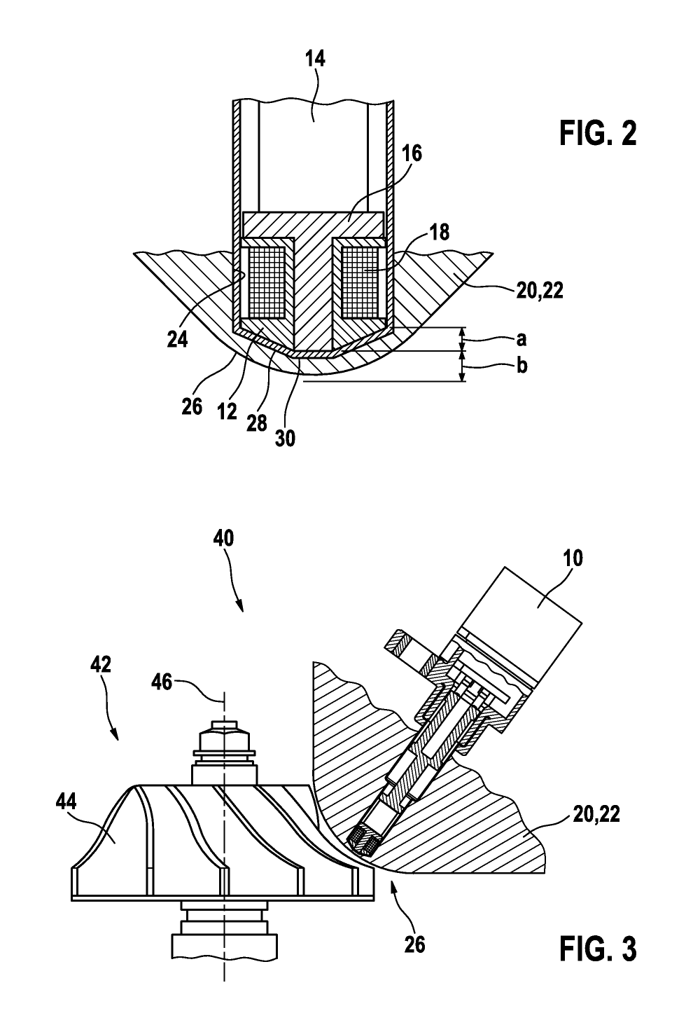

FIG. 2 provides an enlarged representation of the region of magnetic sensor 18 of sensor device 10, together with a housing section 20 of a compressor housing 22. This detailed view shows sensor device 10 in a state of being mounted in housing section 20.

In the area of housing section 20, compressor housing 22 preferably includes a bore 24 for this purpose, particularly a blind-end bore. In the shown region of housing section 20, compressor housing 22 is contoured with a contour 26 adapted essentially to the contour of a compressor wheel that is not shown, particularly the contour of a compressor blade. In addition, FIG. 2 shows that sensor housing 12, in the area of the elongated section of pole pin 16, includes a section 28 of sensor housing 12, which preferably forms an end face 30 that is adapted to contour 26 of compressor housing 22, out of which end face 30, pole pin 16, elongated by length ‘a’, preferably does not project. The adaptation of end face 30 of sensor housing 12 to contour 26 of compressor housing 22 means that a minimum wall thickness, to be maintained corresponding to the width of sensor device 10, between bore 24 and outer contour 26 of compressor housing 22, both in the area of the outer corners of bore 24 and in a central area of bore 24, is particularly maintained throughout the elongation section of length ‘a’ of pole pin 16.

With pole pin 16 elongated by the section of length ‘a’, which section is not enclosed by magnetic sensor 18, a repeated diminution of distance ‘b’ between sensor device 10 and a rotating element 42, not shown, is able to be effected. This results in the particularly advantageous effect that the magnetic field yoke, which essentially corresponds to the distance ‘b’ between the end of pole pin 16, facing rotating element 42 and rotating element 42, is reduced.

Furthermore, there is shown in the illustration of FIG. 3, a possible specific example embodiment of a compressor 40 that includes a sensor device 10 mounted in compressor housing 22. In the embodiment shown in FIG. 3, compressor blades 44, situated on a compressor wheel 42, in their in-common motion about rotational axis 46 in the region of housing section 20, are led past end face 30 of sensor device 10. In this connection, in particular, an eddy current field, generated by magnetic field generator 14 of sensor device 10 is trapped by compressor blades 44, that are made preferably of an electrically conductive material, and, because of their motion essentially perpendicular to the alignment of the magnetic field, the magnetic flux lines conducted by pole pin 16 to magnetic field generator 14 are affected in such a way that a fluctuation of the magnetic flux within pole pin 16 induces a current in magnetic sensor 18 enclosing pole pin 16. This induction voltage, generated in magnetic sensor 18 based on the effect on the field by the eddy currents in the compressor blades 44, is able to be captured by sensor device 10 and be utilized optionally directly as an output signal of sensor device 10 or to generate a corresponding output signal.

1-10. (canceled)

11. A sensor device for acquisition of at least one rotational characteristic of a rotating element, the sensor device comprising:
a magnetic field generator configured for generating a magnetic field at a location of the rotating element;
a magnetic sensor configured for detecting a magnetic field generated by eddy currents of the rotating element;
a pole pin partially enclosed by the magnetic sensor, wherein an end of the pole pin facing the rotating element is elongated, to form a section of the pole pin that is not enclosed by the magnetic sensor.

12. The sensor device of claim 11, further comprising:
a sensor housing that encloses the magnetic field generator and the pole pin and that, at an end of the sensor housing facing the rotating element, includes a tapered section.

13. The sensor device (10) of claim 12, wherein a shape of the tapered section is conically obtuse.

14. The sensor device (10) of claim 12, wherein the section of the pole pin extends into the tapered section of the sensor housing.

15. The sensor device of claim 11, wherein the magnetic sensor includes at least one coil.

16. The sensor device of claim 15, wherein the at least one coil at least partially encloses the pole pin.

17. The sensor device of claim 11, wherein the magnetic field generator includes at least one permanent magnet.

18. The sensor device of claim 17, wherein the magnetic field generator includes only one permanent magnet.

19. The sensor device of claim 11, wherein the sensor device is a plug sensor.

20. The sensor device of claim 19, wherein the rotating element is enclosed into a housing that includes a bore into which the plug sensor is pluggable.

21. The sensor device of claim 11, wherein the rotating element is a compressor wheel of an exhaust-gas turbocharger and the at least one rotational characteristic includes a rotational speed of the compressor wheel.

22. A compressor comprising:
a housing;
a compressor wheel enclosed by the housing and including a plurality of compressor blades; and
a sensor device that:
(a) is installed in the housing;
(b) is configured to acquire a rotational property of the compressor wheel; and
(c) includes:
a magnetic field generator configured for generating a magnetic field at a location of the compressor wheel;
a magnetic sensor configured for detecting a magnetic field generated by eddy currents of the compressor wheel;
a pole pin partially enclosed by the magnetic sensor, wherein an end of the pole pin facing the compressor wheel is elongated, to form a section of the pole pin that is not enclosed by the magnetic sensor.

23. The compressor of claim 22, wherein the compressor is adapted for use in an exhaust-gas turbocharger.
